(19) United States
(12) Patent Application Publication
(10) Pub. No.: US 2015/0201608 A1
(43) Pub. Date: Jul. 23, 2015

(54) Window Frame and Assembly for a Hunting Blind

(71) Applicant: Window Trax of Texas LLC, Conroe, TX (US)

(72) Inventors: David E. Steen, Montgomery, TX (US); Charles L. Irvine, Montgomery, TX (US); Paul D. Kleinpeter, Montgomgery, TX (US)

(73) Assignee: WINDOW TRAX OF TEXAS LLC, Montgomery, TX (US)

(21) Appl. No.: 14/614,462

(22) Filed: Feb. 5, 2015

(51) Int. Cl. A01M 31/02; E06B 1/36; E06B 7/02; E06B 3/46; E06B 5/00; E06B 1/12; E06B 1/56

(52) U.S. Cl. CPC A01M 31/025; E06B 1/12; E06B 1/36; E06B 1/56; E06B 3/4609; E06B 5/00; E06B 7/02

(57) ABSTRACT

A window assembly includes upper and lower window frame members formed as a single piece extruded aluminum member. A plurality of tracks are integrally formed with the window frame members. A plurality of separate screen and window units are located within the tracks and may be freely removed or placed in to tracks when the window frame members are secured to a building structure.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates to a window frame and assembly for a hunting blind.

2. Background of the Invention

Window assemblies that are currently used in conjunction with hunting blinds may typically be four to six feet in width and are pivotably mounted to a wall of the blind either at a top portion of the window assembly or at a lower portion of the window assembly. Consequently they must be either held open by a suitable brace or pivoted down to rest against the blind wall. This exposes the entire window opening and can cause noise which may startle game in the vicinity of the blind.

Consequently there is a need for a window assembly for a blind that reduces the exposure of the hunter in the blind and also reduces the risk of startling the game being hunted.

These and other needs in the art are addressed in one embodiment by a window frame that includes an upper and lower window frame member formed of extruded aluminum. The member is of unitary construction and includes multiple tracks for a plurality of separate screen and transparent panels in each track. The upper and lower window frame members may be attached to the blind wall at upper and lower portions of a rectangular opening. The track members are configured so that the multiple, separate screen and windows can be inserted and withdrawn from the side of the track members as will be shown below.

### BRIEF SUMMARY OF SOME OF THE PREFERRED EMBODIMENTS

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a front view of a hunting blind with a window assembly according to an embodiment of the invention;

FIG. 2 illustrates a cross-sectional view taken along line 2-2 of FIG. 1;

FIG. 3 illustrates a perspective view of the end portion of the window assembly shown in FIG. 1; and

FIG. 4 illustrates a cross-sectional view of the track member.

### DETAILED DESCRIPTION OF THE PREFERRED EMBODIMENTS

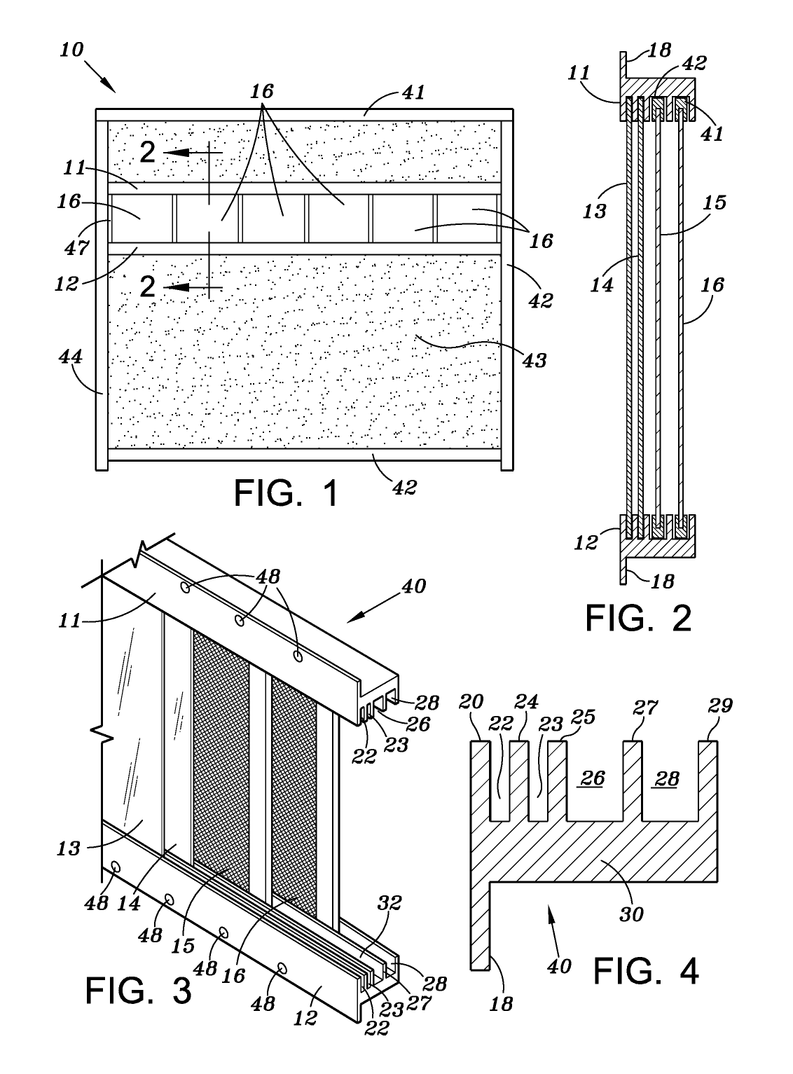

FIG. 1 illustrates a front view of a hunting blind 10 which includes a front wall 43 which may be constructed of any suitable material such as wood. The front wall includes a frame formed by upper and lower members 41 and 42 and side members 42 and 44.

The hunting blind may also include two side walls and a rear wall to form an enclosure. It may also include a roof portion and flooring and a suitable door for entry into the hunting blind.

A generally rectangular opening 47 extends between frame members 42 and 44 in which the window assembly 40 of FIG. 3 is placed.

The window assembly includes a top window frame member 11 which is formed from extruded aluminum and a similar lower window frame member 12. Both window frame members are extruded as a unitary single piece, solid structure. They may be of any suitable length, for example, four to eight feet.

Top window frame member 11 has a flange 17 which is used to attach the member to the front wall by suitable fasteners such as screws or nails that pass through apertures 48 formed in the flange. Flange 17 may abut the exterior or interior surface of wall 43.

Lower window frame member is attached to the lower portion of opening 47 in a similar fashion by flange 18.

Each window frame member includes a solid base portion 30 and a horizontally extending end flange member having portions 20 and 18 extending above and below base portion 30 as shown in FIG. 4.

A plurality of horizontally and vertically extending flanges 24, 25, 27 and 29 extend upwardly from base portion 30 and form horizontal tracks 22, 23, 26 and 28 respectively.

A plurality of screens 16 including frames 51 or 52 can be positioned within upper and lower tracks 28 as shown in FIG. 3. If window frame members 11 and 12 are six feet long for example, then six individual screens having a width of one foot can be positioned within tracks 28. In like fashion six individual screens can be placed within tracks 26 as shown in FIGS. 2 and 3.

Tracks 22 and 23 are sized to receive a plurality of individual window segments 13 and 14. Window segments may be formed of any transparent or semi-transparent material such as glass, Plexiglass or transparent plastics. The screens and windows that slide within tracks 22, 23, 26 and 28 has less tendency to bind as is the case with tracks formed of plastics or vinyls.

As shown in FIG. 4, tracks 22, 23, 26 and 28 having varying widths due to the varying spacing between flanges 20, 24, 25, 27 and 29.

As an example, the width of tracks 26 and 28 may be ⅜″, tracks 22 and 23 may be ⅛″, body 30 may be ¼″ thick, flanges 18, 20, 24, 25, 27 and 29 may be ⅛″ thick and ½″ in height and flange 18 may be 1″ in height.

Although the present invention and its advantages have been described in detail, it should be understood that various changes, substitutions and alterations may be made herein without departing from the spirit and scope of the invention as defined by the appended claims.

What is claimed is:

1. A window frame member comprising:
a unitary one piece extruded aluminum member having a base portion;
an end flange extending below and above said base portion; and
a plurality of vertically and horizontally extending flanges extending upwardly from said base portion thereby forming a plurality of tracks between the vertically and horizontally extending flanges.

2. A window frame member as claimed in claim 1 wherein there are four vertically and horizontally extending flanges thereby forming four tracks.

3. A window frame member as claimed in claim 1 wherein the tracks have varying widths.

4. A window frame member as claimed in claim 1 wherein the entire frame member is formed as a single piece extruded aluminum body.

5. A window assembly comprising:
first and second window frame members formed as a single piece extruded aluminum body;
said window frame members having a plurality of tracks formed therein for receiving screens and windows;
a plurality of separate screen units positioned with a first track; and
a plurality of separate window units positioned with a second track, said window frame members being generally horizontally oriented and vertically spaced when secured to a structure and being open at their sides whereby the separate screen and window units may be positioned between the first and second frame members in the tracks.

6. A window assembly as claimed in claim 5 wherein the first and second window frame members include a flange for attaching the window assembly around an opening in a structure.

7. A window assembly as claimed in claim 5 wherein there are two screen tracks and two window tracks.

8. A window assembly as claimed in claim 5 where in the screens include screen frames.
